(19) United States
(12) Patent Application Publication
(10) Pub. No.: US 2004/0153369 A1
(43) Pub. Date: Aug. 5, 2004

(54) Business transactions via the internet

(76) Inventor: Michael Bencak, Schenefeld (DE)

Correspondence Address: Michael E Marion, US Philips Corporation, Intellectual Property Department, P O Box 3001, Briarcliff Manor, NY, 10510, US

(21) Appl. No.: 10/250,418

(22) PCT Filed: Dec. 21, 2001
(86) PCT No.: PCT/IB02/02700

(30) Foreign Application Priority Data
Jan. 9, 2001 (DE) 101 00 568.7

(51) Int. Cl. G06F 17/60

(52) U.S. Cl. 705/26; 705/2

(57) ABSTRACT

The invention describes a method of carrying out business transactions via the Internet by means of a server computer system (1). The server computer system (1) receives a request for an article from a customer via a first client computer system (2) and shows certain information from the customer's request on a first web page. A vendor authorized to access this first web page replies to the request and sends the reply to the server computer system (1). The server computer system (1) sends an e-mail with the data from the vendor's reply to the customer. The invention also describes a computer network with a server computer system (1) as well as a server computer system (1).

The invention relates to a method of carrying out business transactions by means of an electronic data network with a server computer system, to a computer network, and to a server computer system.

E-commerce is a term used to denote the use of the technical means of electronic data networks for promoting marketing and sales processes of a company and to open up new paths to business. The individual targets here range from company communication via value creation processes to the selling process, covering all marketing phases. Examples of e-commerce applications are on-line shopping, customer service, and electronic data interchange (EDI).

The Internet is an electronic data network with a plurality of connected computers and computer networks. The connected computers may exchange information with one another by means of a service, for example the World Wide Web (WWW). The WWW service enables a server computer system, for example a web server, to send a graphic web page as a piece of information to a connected client computer system.

Each computer and each web page (so-called resources) of the WWW is unequivocally identifiable by means of a uniform resource locator (URL). To indicate a certain web page, the client computer system specifies the URL of this page in the form of a request, for example as a hypertext transfer protocol (HTTP) request. This request is passed on to the web server which supports this web page. When the web server receives the request, it sends the web page to the client computer system. The client computer system then displays this web page by means of a browser. A browser is a special application program which deals with requests for web pages and the display of web pages.

Many web servers have been developed in the World Wide Web by now, by means of which vendors advertise products and can also sell them. The product range varies from items such as music, which is delivered electronically to the customer via the Internet, to items (domestic appliances, computers and fringe equipment, electronic devices) which are sent to the customer through traditional transport channels.

For an on-line shopping selection, a server computer system may provide, for example, an electronic version of a catalogue which contains a wide range of products together with their descriptions and price information. A customer can view the catalogue via a browser and can select products to be ordered, if so desired. Once the customer has selected all products for his order, the server computer system requests further information necessary for an order. This further information may comprise, for example, the name of the customer, his credit card number, and the delivery address. The server computer system usually acknowledges the order by sending a web page which indicates the order information and, for example, also the delivery times.

Among the advantages of on-line shopping are the possibility of buying/ordering during 24 hours of the day and the availability of detailed product information. It is not necessary for a customer wanting to buy less common products to find specialized businesses which sometimes are not present in the vicinity of the customer. In addition, the customer can immediately see in the case of on-line shopping whether the desired goods are in stock and immediately available.

The payment by credit card, however, in particular frightens off many customers from ordering goods via on-line shopping. This is because the credit card number of the customer passes through many different computer systems after the order has been sent towards the vendor and may become known to third parties on its way. An encoded transmission of the credit card number only provides a limited protection, because encoded data can be decoded by third parties by means of decoding computer programs.

It is accordingly an object of the present invention to provide a method whereby business transactions via the Internet can be carried out in a fast manner and with a high degree of security for the customer.

This object is achieved by means of methods for business transactions by means of an electronic data network with a server computer system which receives a request for an article from a customer via a first client computer system, displays certain data of the customer's request on a first web page, receives a reply of a vendor to a request via a second client computer system, and sends an e-mail with the data from the vendor's reply to the first client computer system of the customer.

What is advantageous for the customer in this routing of the business transactions is the security in the subsequent financial transaction. The customer need not put in his credit card number and transmit it to the business/vendor via the electronic data network, but he can arrange the payment details individually with the vendor.

This system is particularly advantageous for a customer in searching a special article because the customer need no longer search for several outlets; instead, a vendor who has the desired product in stock approaches the customer.

Since the customer buys the product from a vendor, he will have no subsequent service problems in the case of complaints, repairs, etc.

The operator of the server computer system, for example a company, has the advantage that it can incorporate its existing interest in the Internet trade. Furthermore, the service for vendors and customers is improved without a special software having to be acquired or used.

The method as defined in claim 2 has the advantage that the customer has to disclose only few personal data and can remain anonymous until he makes himself known to the vendor.

A limited access to the first web page as defined in claim 3 enables the operator of the server computer system to safeguard that only vendors authorized by the operator can make offers. This results in a high quality standard of the vendors and thus of the entire procedure.

It is achieved by the advantageous method as claimed in claim 4 that the customer receives all data and indicators relevant to him and the business transaction.

The method of claim 5 has the advantage that erasing of the request from a customer after it has been answered safeguards that the customer does not continue to receive e-mails with offers from vendors for days and weeks afterwards. The advantage for the vendor is that no price war can arise among the vendors, in which several vendors make offers to a customer, undercutting each other's prices.

A statistical tool for the operator of the server computer system and the vendor is created by means of the methods according to the invention as claimed in claim 6 and claim 7. The operator and the vendor can obtain an overview of the success of the business transactions and the resulting turnover in a simple and fast manner.

It is achieved by the advantageous measures of claims 8, 9, and 10 that a vendor supplies the form containing the statistical data. Furthermore, the operator of the server computer system can identify those vendors who misuse the system for carrying out business transactions.

The electronic data networks advantageously defined in claim 11 enable the operator of the server computer system to select which client computer system it allows to take part in the process.

The invention further relates to a computer system with a server computer system, and to a server computer system, each being provided so as to receive a request for an article from a customer via a first client computer system, display certain data of the customer's request on a first web page, receive a reply of a vendor to a request via a second client computer system, and send an e-mail with the data from the vendor's reply to the first client computer system of the customer.

Embodiments of the invention will be explained in more detail below. In the drawing:

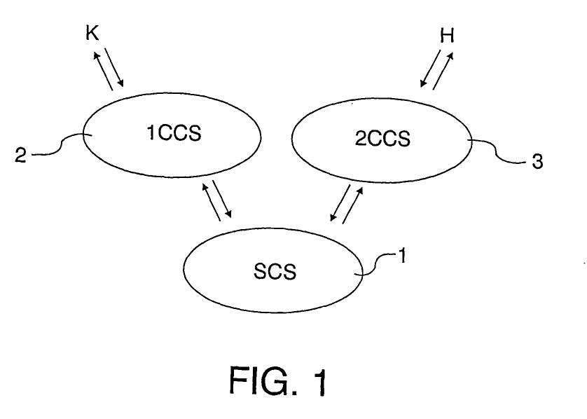

FIG. 1 shows the computer systems taking part,

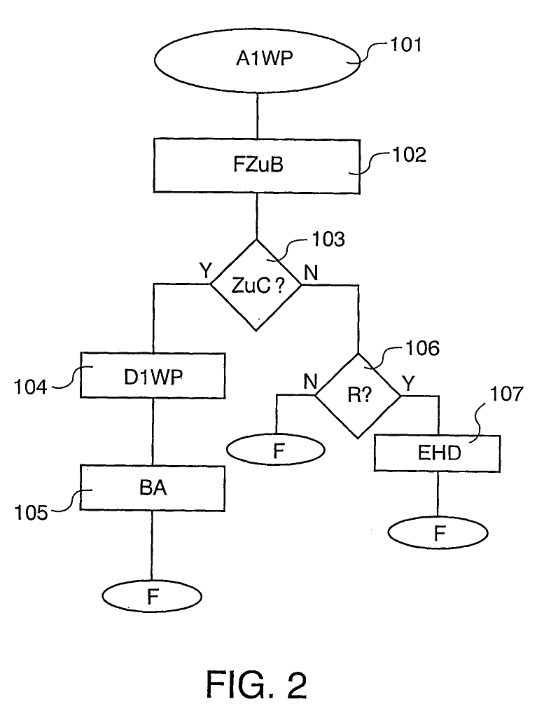

FIG. 2 is a flowchart of a routine according to which a vendor accesses the first web page, and

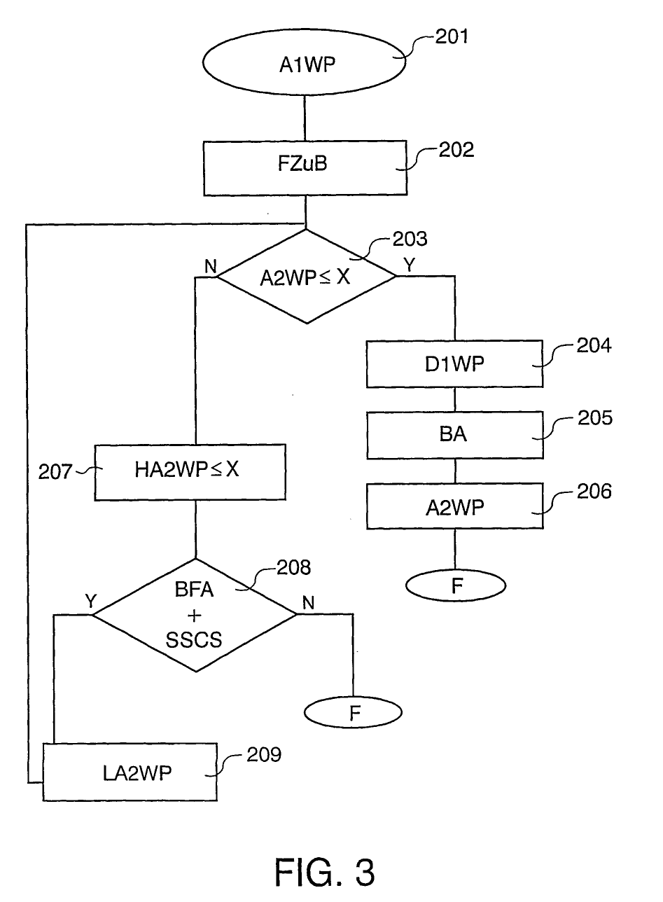

FIG. 3 is a flowchart of an alternative routine according to which a vendor accesses the first web page.

FIG. 1 shows the computer systems which take part in business transactions via a computer network. A customer (K) can make contact with a server computer system 1 (SCS), for example of a company, via a first client computer system (1CCS) 2. Similarly, a vendor (H) may make contact with the server computer system 1 via a second client computer system 3 (2CCS).

A customer can view an electronic catalogue of goods of a company, for example production goods or services, by means of a server computer system 1 of the company and a first client computer system 2. If the customer is interested in one or several articles, he carries out an action, for example clicking a button on a web page, entering data via a keyboard, or entering spoken words, so as to arrive at a web page with an order form. On this order form, the customer indicates his e-mail address, which articles he is interested in, and his address including the postal code. It may be advantageous in some cases that the customer also indicates the quantity of goods. This order form is then sent to the server computer system 1 of the company via the first client computer system 2. Certain data on the order form, such as the nature of the goods, address, and postal code of the customer, and possibly the quantity of goods, are shown on a first web page.

A vendor can view the first web page via a second client computer system 3. If he wants to reply to the request from the customer, he carries out an action, for example clicking a button on the first web page, putting in data on a keyboard, or putting in a spoken signal, so as to arrive at a web page with a reply form. On this reply form the vendor enters his name, his company address, the nature of the goods in stock, possibly the quantity of the available goods, and the selling price for the goods. This reply form is then sent to the server computer system 1 of the company via the second client computer system 2. The server computer system 1 passes on the data from the vendor's reply form via the first client computer system 2 to the e-mail address of the customer.

When a vendor has replied to the request from a customer, the server computer system 1 erases the request from the first web page. This ensures that the customer will not continue to receive e-mails with offers from vendors for days and weeks afterwards. In addition, an active vendor is rewarded thereby and a price war between vendors is avoided.

The company operating the server computer system 1 may be, for example, an electronics company which provides information about its products on its homepage (http://www.philips.de) in the form of an electronic catalogue (http://www.philips.de/pcp-partner). It may be advantageous for the operator of the server computer system 1 to allow access to the first web page via the second client server 3 to certain vendors only so as to utilize the long-term partnership with the vendors as well as their advisory competence and to provide a customer with a qualified vendor.

A possibility of allowing only certain vendors access to the first web page is shown in FIG. 2.

In the first step 101, the vendor sends a request 4 for the first web page (A1WP) to the server computer system 1 via the second client computer system 3: In the second step 102, the server computer system 1 sends a web page with a question as to an access authorization (FZuB) via the second client computer system 3. If the vendor in the next step 103 can enter an access code (ZuC?), for example a password granted to him by the operator of the server computer system 1, the first web page is displayed (D1WP) in the subsequent step 104. Here he can view the requests from the customers. If the vendor wants to reply to a request, he completes a reply form (BA) in the next step 105 and sends this via the second client computer system to the server computer system 1. This completes the routine (F).

If the vendor is incapable of entering an access code in step 103, the server computer system 1 sends a web page with a registration form (R?) in step 106. If the vendor wishes to become registered, he enters his data (EHD) on the form in step 107 and sends it through the second client computer system 3 to the server computer system 1. This completes this routine (F).

After the data have been positively adjudged by the operator of the server computer system 1, an access code is provided to the vendor, for example by post.

The server computer system will end this routine (F) if the vendor performs an action, for example clicking of a button on the first web page, an input via the keyboard, or a spoken input, indicating to the server computer system 1 that he does not want to be registered in step 106.

In a further embodiment of the invention, a request from a customer which was answered by a vendor is not erased but displayed on a second web page which is reserved for a certain vendor. Only this certain vendor has access to this second web page. Preferably, said answered request can only be erased from the second web page after the vendor has completed a form with statistical data and has sent it to the server computer system 1. To safeguard that a vendor will complete the form with the statistical data, it may be advantageous to grant a vendor access to the first web page only if the number of answered requests on the second web page reserved for this vendor does not exceed a certain number x.

This embodiment is depicted in FIG. 3. After the vendor has sent a request for the first web page to the server computer system 1 via the second client computer system 3 (A1WP) in the first step 201, the server computer system 1 sends a web page with the request for the access authorization (FZuB) via the second client computer system 3 as the second step 202. After the access code has been put in, the server computer system 1 tests in the next step 203 whether the number of answered requests on the second web page assigned to this vendor is smaller than or equal to a number x. If the number of answered requests on the second web page assigned to this vendor is smaller than or equal to the number x, the first web page is shown to the vendor (D1WP) in the next step 204. He can then reply to a request from a customer (BA) in the next step 205, and the answered request is shown on a second web page (A2WP). This completes this routine (F). The number x is an integer number and its value is laid down by the operator of the server computer system 1.

If the number of answered requests is greater than x, it is indicated to the vendor in the next step 207 by means of a web page that too many answered requests are present on the second web page assigned to him (HA2WP≦x). If the vendor completes a form with statistical data (BFA) in the next step 208 and sends the form as a web page via the second client computer system 3 to the server computer system 1 (SSCS), the server computer system 1 will erase the corresponding request from the second web page (LA2WP) in the next step 209. The number of answered requests on the second web page will be equal to x after that, and the vendor can have the first web page shown to him.

If the vendor does not complete the form in step 208, the server computer system 1 ends this routine (F).

The embodiments of the invention explained above represent examples of how it may be realized and are not designed to restrict the scope of the invention. Alternatively, for example, the requests from the customers may be subdivided into different regions on the basis of the postal codes, and a vendor may be granted access only to a first web page which contains requests from his own region.

1. A method for business transactions by means of an electronic data network with a server computer system (1) which
receives a request for an article from a customer via a first client computer system (2), displays certain data of the customer's request on a first web page,
receives a reply of a vendor to a request via a second client computer system (3), and sends an e-mail with data from the vendor's reply to the first client computer system (2) of the customer.

2. A method of carrying out business transactions by means of an electronic data network as claimed in claim 1, characterized in that the request from the customer contains his e-mail address, his address including the postal code, and data on the ordered goods.

3. A method of carrying out business transactions by means of an electronic data network as claimed in claimed 1, characterized in that the server computer system (1) grants access to the first web page via the second client server system (3) to certain vendors only.

4. A method of carrying out business transactions by means of an electronic data network as claimed in claim 1, characterized in that the reply from the vendor contains his name, his company address, and a quoted price for the goods.

5. A method of carrying out business transactions by means of an electronic data network as claimed in claim 1, characterized in that the request is erased from the first web page after the reply has been given.

6. A method of carrying out business transactions by means of an electronic data network as claimed in claim 1, characterized in that the request after being answered is shown on a second web page which is reserved for a certain vendor.

7. A method of carrying out business transactions by means of an electronic data network as claimed in claim 6, characterized in that only said certain vendor has access to said second web page via the second client computer system (3).

8. A method of carrying out business transactions by means of an electronic data network as claimed in claim 6, characterized in that only a maximum number of answered requests can be shown on the second web page.

9. A method of carrying out business transactions by means of an electronic data network as claimed in claim 8, characterized in that the vendor cannot answer any requests on the first web page when a maximum number of answered requests has been reached on the second web page.

10. A method of carrying out business transactions by means of an electronic data network as claimed in claim 6, characterized in that an answered request is erased from the second web page only if a form is completed and is sent as a web page to the server computer system (1).

11. A method of carrying out business transactions by means of an electronic data network as claimed in claim 1 or 6, characterized in that the electronic data network is chosen from the group comprising the Internet, Extranet, and Intranet.

12. A computer network with a server computer system (1) which is designed so as to
receive a request for an article from a customer via a first client computer system (2),
display certain data of the customer's request on a first web page,
receive a reply of a vendor to a request via a second client computer system (3), and
send an e-mail with data from the vendor's reply to the first client computer system (2) of the customer.

13. A server computer system (1) which is designed so as to
receive a request for an article from a customer via a first client computer system (2),
display certain data of the customer's request on a first web page,
receive a reply of a vendor to a request via a second client computer system (3), and
send an e-mail with data from the vendor's reply to the first client computer system (2) of the customer.
